(19) United States
(12) Patent Application Publication
(10) Pub. No.: US 2025/0221579 A1
(43) Pub. Date: Jul. 10, 2025

(54) LOW-NOISE BUBBLE SURFING FOLDING FOOT BATH TUB

(71) Applicant: Shenzhen Sibaitong Intelligent Technology Co., Ltd., Shenzhen (CN)

(72) Inventor: Houyang GE, Shenzhen (CN)

(73) Assignee: Shenzhen Sibaitong Intelligent Technology Co., Ltd., Shenzhen (CN)

(21) Appl. No.: 18/415,167

(22) Filed: Jan. 17, 2024

(30) Foreign Application Priority Data
Jan. 10, 2024 (CN) 2024200664389

(51) Int. Cl. A47K 3/062

(52) U.S. Cl. CPC A47K 3/062

(57) ABSTRACT

The utility model relates to the field of daily necessities, a low-noise bubble surfing folding foot bath tub, include foot bath tub assembly, container and a cavity located at the bottom of the container, the bottom of the container is provided with a pedal position. The surfing effect component is arranged in the cavity at the bottom of the container Includes water pump, inlet and outlet pipes, wherein the water inlet end of the water pump is connected with the first end of the water inlet pipe, the water outlet end of the water pump is connected with the first section of the water outlet pipe, the second end of the water inlet pipe and the second end of the water outlet pipe are both connected to a pedal by the pedal bottom. foot bath tub can realize the use feeling of foot bubble surfing, foldable and easy to store.

### CROSS-REFERENCE TO RELATED APPLICATIONS

The application claims priority to Chinese patent application No. 2024200664389, filed on Jan. 10, 2024, the entire contents of which are incorporated herein by reference.

### TECHNICAL FIELD

The utility model relates to the field of daily necessities, in particular to a low-noise bubble surfing folding foot bath tub.

### BACKGROUND

The foot bath tub in the prior art can only realize the simple function of soaking feet, and the use effect is relatively simple.

Some foot baths are layered with massage components and realize massage function. Generally, a movable massage component is arranged at the bottom of the foot bath to stimulate the soles of feet and promote blood circulation through the action of the massage component. The massage parts of this kind of foot bath generally form an action, which is relatively simple.

### SUMMARY

In order to solve the above problems, the utility model puts forward a low-noise bubble surfing folding foot bath tub, which can realize the use feeling of foot bubble surfing and is foldable and easy to store.

In order to achieve the above purpose, the technical scheme adopted by the utility model is as follows:

A low-noise bubble surfing folding foot bath tub comprises
The foot bath component comprises a container and a cavity located at the bottom of the container, wherein the bottom of the container is provided with a pedal, and the pedal is provided with a pedal position;
The surfing effect component is arranged in the cavity at the bottom of the container and comprises a water pump, a water inlet pipe and a water outlet pipe, wherein the water inlet end of the water pump is connected with the first end of the water inlet pipe, the water outlet end of the water pump is connected with the first section of the water outlet pipe, and the second end of the water inlet pipe and the second end of the water outlet pipe are both connected to a pedal by the pedal bottom.

Preferably, the connecting line between the second end of the water inlet pipe and the second end of the water outlet pipe passes through the pedal position.

Preferably, the pedal is provided with two surfing heads, each of which corresponds to a pedal position, and the water outlet terminal of the surfing effect component is connected with the surfing heads.

Preferably, the water outlet end of the surfing head faces the pedal position.

Preferably, the water inlet pipe is a corrugated hose.

Preferably, the pedal is also provided with two bubble generating heads, and the bubble generating heads are arranged at corresponding pedal positions of the pedal; The cavity at the bottom of the container further comprises

A bubble effect component, a bubble pump and a bubble output pipe, wherein the first section of the bubble output pipe is connected with the output end of the bubble pump, and the output end of the bubble output pipe is connected with the bubble generating head through a tee structure and a pipeline.

Preferably, the bubble effect component is installed at the bottom of the pedal through the suspension gasket to make the bubble effect component work silently.

Preferably, the pedal is also provided with a massage component which can passively rotate.

Preferably, the foot bath tub assembly comprises a base, a pedal assembly, a soft enclosure structure and an upper enclosure, wherein the top surface of the pedal assembly is a pedal structure, and the pedal assembly and the base are matched to form a cavity;

The peripheral edge of that pedal assembly extend upwards to form a low enclosure, and the lower enclosure and the upper enclosure are connected through a soft enclosure structure, and the peripheral contour of the upper enclosure is larger than that of the low enclosure.

Preferably, the base includes a support rod and a receiving groove. The first end of the support rod is connected to the base through a universal joint, and the receiving groove is set near the support rod. The support rod can support the lower part of the upper enclosure to unfold the container, or the support rod can rotate along the connection with the base and be placed in the receiving groove to fold and store the container.

The utility model has the beneficial effects that:

According to the low-noise bubble surfing folding foot bath tub, the water circulation in the container can be realized through the surfing effect component, the user's feet in the container can be washed through the water circulation, and bubbles can be inflated in the bottom of the feet through the bubble effect component, so that the user can get richer body feeling by combining the surfing effect component; By using the suspension gasket, the noise produced by the bubble effect module can be reduced.

In addition, the low-noise bubble surfing folding foot bath tub can realize the folding and storage effect through the cooperative use of the base, the pedal assembly, the soft enclosure structure and the upper enclosure board, and has small occupied space in the non-use state and convenient storage.

### BRIEF DESCRIPTION OF DRAWINGS

FIG. 1 is a schematic diagram of the bottom of the low-noise bubble surfing folding foot bath tub of the utility model.

FIG. 2 is a schematic diagram of the surfing effect component in FIG. 1.

FIG. 3 is a schematic view of the bubble effect assembly in FIG. 1.

FIG. 4 is an effect diagram of the low-noise bubble surfing folding foot bath tub of the utility model fully unfolded.

FIG. 5 is a schematic view of the support rod in FIG. 4 after folding.

FIG. 6 is a schematic view of the folding state of the low-noise bubble surfing folding foot bath tub of the utility model.

Reference numerals include:
11—base, 111—support rod, 112—holding groove, 113—wire holding device, 12—pedal assembly, 121—bubble generating head, 122—massage assembly, 123—surfing head, 13—soft enclosure structure, 14—upper enclosure;
2—surfing effect component, 21—water pump, 22—water inlet pipe and 23—water outlet pipe;
3—bubble effect assembly, 31—bubble pump, 32—bubble output pipe, 33—tee structure, 34—one-way valve, 35—suspension gasket.

### DETAILED DESCRIPTION OF THE EMBODIMENTS

In order to make the purpose, technical scheme and advantages of this technical scheme more clear, this technical scheme will be further explained in detail with specific embodiments. It should be understood that these descriptions are only exemplary, and are not intended to limit the scope of this technical solution.

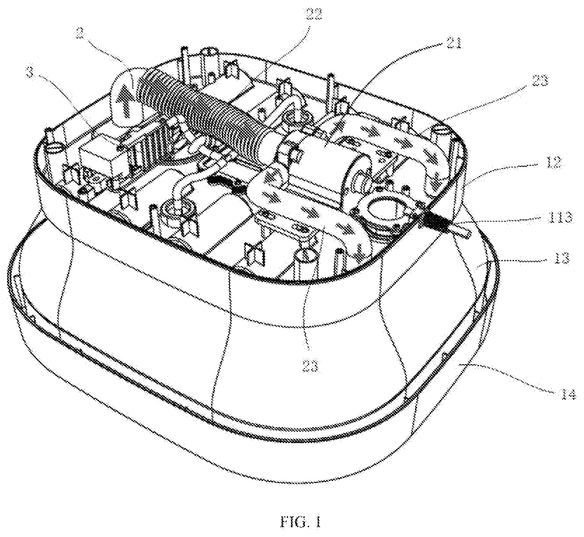

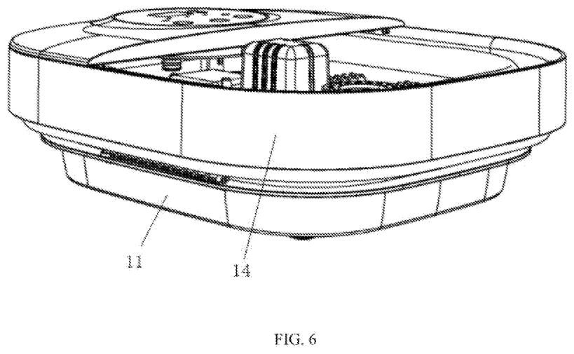

As shown in FIG. 1-FIG. 6, this embodiment proposes a low-noise bubble surfing folding foot bath tub, which comprises a foot bath tub assembly, including a container and a cavity located at the bottom of the container, wherein the bottom of the container is provided with a pedal with a pedal position; The surfing effect module 2 is arranged in the cavity at the bottom of the container and comprises a water pump 21, a water inlet pipe 22 and a water outlet pipe 23, wherein the water inlet end of the water pump 21 is connected with the first end of the water inlet pipe 22, the water outlet end of the water pump 21 is connected with the first section of the water outlet pipe 23, and the second end of the water inlet pipe 22 and the second end of the water outlet pipe 23 are both connected with pedals through the bottoms of pedals.

Specifically, the external shell member of the foot bath tub in this embodiment is mainly composed of a base 11, a pedal assembly 12, a soft enclosure structure 13 and an upper enclosure 14. In this embodiment, the middle of the pedal assembly 12 forms a pedal horizontally. Since the pedal assembly 12 and the base 11 are combined to form a cavity below the pedal, the surfing effect assembly 2, the bubble effect assembly 3 and related electrical equipment are all arranged in the cavity.

Specifically, the water inlet pipe 22 in the surfing effect module 2 communicates with the inside of the container and the input end of the water pump 21, and the output end of the water pump 21 communicates with the pedal through the water outlet pipe 23, so the water pump 21 can drive the water body to return from the water inlet pipe 22 and drain from the water outlet pipe 23, and the water body also forms a flowing effect in the container, so the most basic surfing effect can be achieved through the surfing effect module 2.

In order to make the surfing effect better, the connecting line between the second end of the water inlet pipe 22 and the second end of the water outlet pipe 23 passes through the pedal position, so after the user steps on the pedal position, the surfing effect module 2 can drive the water body to pass through the user's feet during the circulation in the container, thus enhancing the surfing experience.

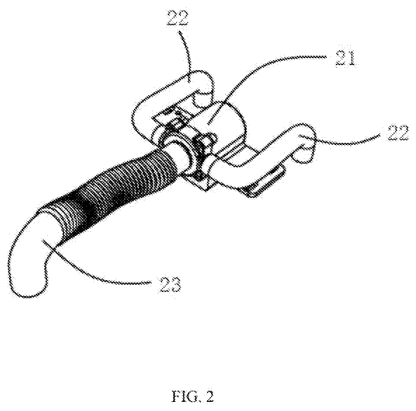

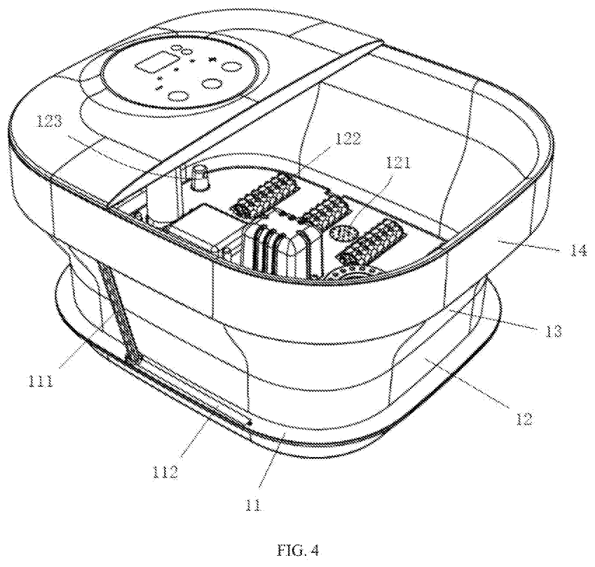

There are two surfing heads 123 on the pedal, each of which corresponds to a pedal position, and the water outlet terminal of the surfing effect module 2 is connected with the surfing heads 123. As shown in connection with FIG. 4. The surfing head 123 is arranged at the front of the pedal top surface corresponding to the pedal position, the backwater part of the surfing effect component 2 is arranged at the rear of the pedal corresponding to the pedal position, the water outlet end of the surfing head 123 faces the pedal position, and the water circulated by the surfing effect component 2 is output through the surfing head 123, which directly impacts the user's foot, so that the comfort is better. As shown in FIG. 2, in this embodiment, the water inlet pipe 22 is a corrugated hose, and the corrugated hose can be bent at will during installation to achieve the effect of avoiding the position without changing the minimum cross section of the pipe body.

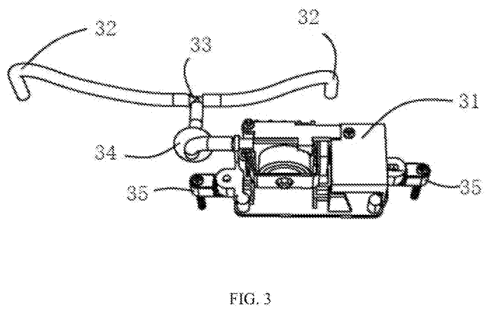

As shown in FIG. 3, there are also two bubble generating heads 121 on the pedal, and the bubble generating heads 121 are arranged at the corresponding pedal positions; The cavity at the bottom of the container also includes a bubble effect module 3, a bubble pump 31 and a bubble output pipe 32. The first section of the bubble output pipe 32 is connected with the output end of the bubble pump 31, and the output end of the bubble output pipe 32 is connected with the bubble generating head 121 through a tee structure 33 and a pipeline. The bubble effect assembly 3 is installed at the bottom of the pedal through the suspension gasket 35 to make the bubble effect assembly 3 work silently.

In this embodiment, the bubble pump 31 is not added to the bubble effect module 3, and the bubble pump 31 is installed at the lower part of the pedal through two sets of suspension pads 35, so the vibration generated during the operation of the bubble pump 31 can be directly reduced or eliminated through the suspension pads 35, so as to prevent the noise generated by the vibration from affecting the use experience.

The output end of the bubble pump 31 is connected with the first end of the three-way structure 33 through a pipeline, and the second end and the third section of the three-way structure 33 are respectively connected with the bubble generating head 121 through a pipeline, so the gas output by the bubble pump 31 is diverted through the three-way structure 33, and the gas is output to the pedal position through the bubble generating head 121 respectively, that is, the bubble generating head 121 generates bubbles below the pedal position. In order to prevent the water body from returning to the bubble pump 31 through the bubble output pipe 32, a one-way valve 34 is arranged on the communicating pipeline between the tee structure 33 and the bubble pump 31 to prevent the bubble pump 31 from contacting the water body and being damaged.

The pedal is also provided with a massage assembly 122 that can passively rotate, so that the user can step on the pedal position to make the sole of the foot contact the massage assembly 122 and drive the massage assembly 122 to passively massage the sole of the foot.

The footbath assembly comprises a base 11, a pedal assembly 12, a soft enclosure structure 13 and an upper panel 14, wherein the top surface of the pedal assembly 12 is a pedal structure, and the pedal assembly 12 cooperates with the base 11 to form a cavity;

The peripheral edges of the pedal assembly 12 extend upward to form a lower enclosure, and the lower enclosure and the upper enclosure are connected by a soft enclosure structure 13, and the outer contour of the upper enclosure is larger than that of the lower enclosure.

Referring to FIGS. 4-6, the base 11 includes a support rod 111 and an accommodating groove 112. The first end of the support rod 111 is hinged on the base 11, and the accommodating groove 112 is arranged adjacent to the support rod 111, and the support rod 111 can be supported at the lower part of the upper enclosure plate 14 to unfold the container. Or the support rod 111 rotates along the hinge with the base 11 and is placed in the receiving groove 112, so that the container can be folded and received.

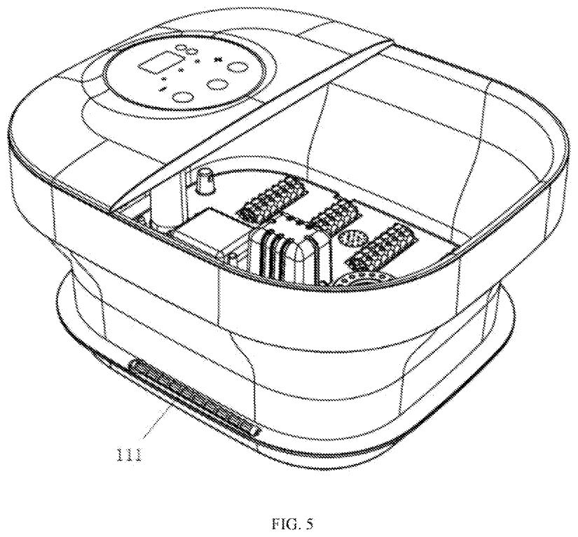

As shown in FIG. 4, after the container is unfolded, the support rod 111 can be rotated at the lower edge of the upper enclosure 14 through the hinge, so that the upper enclosure 14 will not sink due to its own weight. As shown in FIG. 5, when storage is needed, the support rod 111 is rotated and placed in the storage slot 112, and then the upper enclosure plate 14 is pressed down. Because the soft enclosure structure 13 is deformable and the outer contour of the upper enclosure is larger than that of the lower enclosure, the upper enclosure can be sleeved at the outer periphery of the lower enclosure to complete the folding, and the space occupied in the non-use state is small, which is convenient for storage.

In addition, in order to facilitate the wire storage of the foot bath tub, a wire storage device 113 is also arranged in the cavity between the pedal assembly 12 and the base 11, which can automatically store the power supply wire.

The above contents are only the preferred embodiments of this utility model. For ordinary technicians in this field, many changes can be made in the specific implementation and application scope according to the idea of this technical content, as long as these changes do not deviate from the concept of this utility model, they all belong to the protection scope of this patent.

The foot bath assembly includes a base 11, a pedal assembly 12, a soft enclosure structure 13, and an upper panel 14. The top surface of the pedal assembly 12 is a pedal structure, and the pedal assembly 12 cooperates with the base 11 to form a cavity. The peripheral edges of the pedal assembly 12 extend upward to form a lower enclosure, and the lower enclosure and the upper enclosure are connected by a soft enclosure structure 13, with the outer contour of the upper enclosure larger than that of the lower enclosure.

Referring to FIGS. 4-6, the base 11 comprises a support rod 111 and an accommodating groove 112. The first end of the support rod 111 is connected on the base 11, and the accommodating groove 112 is arranged adjacent to the support rod 111. The support rod 111 can be supported at the lower part of the upper enclosure plate 14 to unfold the container. Alternatively, the support rod 111 rotates along universal ball head of the connected with the base 11 and is placed in the receiving groove 112, allowing the container to be folded and stored.

As shown in FIG. 4, after the container is unfolded, the support rod 111 can be Wanxiang ball head rotated at the lower edge of the upper enclosure 14 through the hinge, preventing the upper enclosure 14 from sinking due to its own weight. As shown in FIG. 5, when storage is needed, the support rod 111 is rotated and placed in the storage slot 112, and then the upper enclosure plate 14 is pressed down. Because the soft enclosure structure 13 is deformable and the outer contour of the upper enclosure is larger than that of the lower enclosure, the upper enclosure can be sleeved at the outer periphery of the lower enclosure to complete the folding, and the space occupied in the non-use state is small, which is convenient for storage.

Additionally, to facilitate the wire storage of the foot bath tub, a wire storage device 113 is also arranged in the cavity between the pedal assembly 12 and the base 11, which can automatically store the power supply wire.

The above contents are only the preferred embodiments of this utility model. For ordinary technicians in this field, many changes can be made in the specific implementation and application scope according to the idea of this technical content, as long as these changes do not deviate from the concept of this utility model, they all belong to the protection scope of this patent.

What is claimed is:

1. A low-noise bubble surfing folding foot bath tub, comprising
The foot bath component comprises a container and a cavity located at the bottom of the container, wherein the bottom of the container is provided with a pedal, and the pedal is provided with a pedal position;
The surfing effect component is arranged in the cavity at the bottom of the container and comprises a water pump, a water inlet pipe and a water outlet pipe, wherein the water inlet end of the water pump is connected with the first end of the water inlet pipe, the water outlet end of the water pump is connected with the first section of the water outlet pipe, and the second end of the water inlet pipe and the second end of the water outlet pipe are both connected to a pedal by the pedal bottom.

2. The low-noise bubble surfing folding foot bath tub according to claim 1, characterized in that the connecting line between the second end of the water inlet pipe and the second end of the water outlet pipe passes through the pedal position.

3. The low-noise bubble surfing folding foot bath tub according to claim 1, characterized in that the pedal is provided with two surfing heads, each of which corresponds to a pedal position, and the water outlet terminal of the surfing effect component is connected with the surfing heads.

4. The low-noise bubble surfing folding foot bath tub according to claim 3, characterized in that the water outlet end of the surfing head faces the pedal position.

5. The low-noise bubble surfing folding foot bath tub according to claim 1, wherein the water inlet pipe is a corrugated hose.

6. The low-noise bubble surfing folding foot bath tub according to claim 1, characterized in that the pedal is further provided with two bubble generating heads, and the bubble generating heads are arranged at the corresponding pedal positions; The cavity at the bottom of the container further comprises:
a bubble effect component, a bubble pump and a bubble output pipe, wherein the first section of the bubble output pipe is connected with the output end of the bubble pump, and the output end of the bubble output pipe is connected with the bubble generating head through a tee structure and a pipeline.

7. The low-noise bubble surfing folding foot bath tub according to claim 6, characterized in that the bubble effect component is installed at the bottom of the pedal through a suspension gasket to make the bubble effect component work silently.

8. The low-noise bubble surfing folding foot bath tub according to claim 1, characterized in that the pedal is further provided with a massage component which can passively rotate.

9. The low-noise bubble surfing folding foot bath tub according to claim 1, wherein the foot bath tub assembly comprises a base, a pedal assembly, a soft enclosure structure and an upper enclosure, wherein the top surface of the pedal assembly is a pedal structure, and the pedal assembly and the base cooperate to form a cavity;
The peripheral edge of that pedal assembly extend upwards to form a low enclosure, and the lower enclosure and the upper enclosure are connected through a soft enclosure structure, and the peripheral contour of the upper enclosure is larger than that of the low enclosure.

10. The low-noise bubble surfing folding foot bath tub according to claim 9, characterized in that the base comprises a support rod and an accommodating groove, The first end of the support rod is connected to the base through the universal ball head, accommodating the groove adjacent to the support rod setting; Or the support rod rotates along the connection with the base and is arranged in the accommodating groove, so that the container is folded and accommodated.
